(19) United States
(12) Patent Application Publication
(10) Pub. No.: US 2018/0300818 A1
(43) Pub. Date: Oct. 18, 2018

(54) MENTOR AND MENTEE MATCHING USING SOCIAL NETWORKING DATA

(71) Applicant: Linkedln Corporation, Sunnyvale, CA (US)

(72) Inventors: Victor Louis Kabdebon, Sunnyvale, CA (US); Romer E. Rosales, Burlingame, CA (US); Kinjal Basu, Stanford, CA (US); Shaunak Chatterjee, Sunnyvale, CA (US); Richard Ramirez, Los Altos, CA (US); Hari Srinivasan, Palo Alto, CA (US); Daniel Weizman, San Francisco, CA (US)

(21) Appl. No.: 15/485,901

(22) Filed: Apr. 12, 2017

(51) Int. Cl. G06Q 50/00; G06Q 10/10

(52) U.S. Cl. CPC G06Q 50/01; G06Q 10/105

(57) ABSTRACT

Disclosed in some examples are methods, systems, and machine-readable mediums for matching mentee members with mentor members. The member matching may utilize social networking service data and one or more preferences of both the potential mentees and potential mentors. For example, after indicating an interest in being mentored (e.g., being a mentee), a member may be presented with a list of potential mentors that are selected, scored, and in some examples, ranked based upon the member's preferences, the potential mentors' preferences, and other compatibility factors. The member may then select one or more of these potential mentors.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram showing the functional components of a social networking service according to some examples of the present disclosure.

FIG. 2 shows a flowchart of a method for matching mentors and mentees according to some examples of the present disclosure.

FIG. 3 shows a diagram of an example Graphical User Interface (GUI) of a user profile page of a member according to some examples of the present disclosure.

FIG. 4 shows a diagram of an example GUI of a user profile page of a user that is shown to a member according to some examples of the present disclosure.

FIG. 5 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services. For example, online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Individuals may benefit in their careers by seeking the assistance of a mentor. A mentor may be more experienced and may offer developmental support to the mentee. For example, by offering support, career guidance, a role model, communication, and advice. A social networking service is in a unique position to provide for automatically matching mentors to mentees as it has access to data that is useful in selecting compatible members. For example, the social networking service may have access to information on who the user knows, what their skillsets are, what industries they are in, where they are located, and the like.

Disclosed in some examples are methods, systems, and machine-readable mediums for matching mentee members with mentor members. The member matching may utilize social networking service data and one or more preferences of both the potential mentees and potential mentors. For example, after indicating an interest in being mentored (e.g., being a mentee), a member may be presented with a list of potential mentors that are selected, scored, and in some examples, ranked based upon the member's preferences, the potential mentors' preferences, and other compatibility factors. The member may then select one or more of these potential mentors. Notifications are then sent to these selected mentors. The selected mentors may then accept or decline the mentorship relationship. Once accepted the system may create a mentorship relationship in the social networking service linking the mentor and mentee members. This relationship may be similar to a connection in that it may entitle the members additional privileges that members without this connection do not have.

While the above described a process by which a mentee obtains a mentor, in other examples, the mentor may choose the mentees instead of the mentee choosing the mentor. Thus, for example, after indicating an interest in being a mentor, the member may be presented with a list of potential mentees that are selected, scored, and in some examples, ranked based upon one or more of the member and the potential mentees' preferences as well as other compatibility factors. The member may then select one or more of these potential mentees. Notifications are then sent to these selected mentees. The selected mentees may then accept or decline the mentorship relationship. In some examples, both the mentee and the mentor may have the opportunity to choose their counterparts in the relationship. Members may be both a mentor to a first member, but also be a mentee of a second member, thus the same member may be both a mentor and a mentee.

In order to perform the recommendation matching, the system may determine the optimal solution to the function:

$${\sum }_{i ∈ A} {\sum }_{j ∈ T} C ( i , j ) {x}_{ij}$$

Such that:

$$0 \leq {x}_{ij} \leq 1$$

$${a}_{i}^{0} \leq {\sum }_{j ∈ T} {x}_{ij} \leq {a}_{i}^{1}$$

$${β}_{j}^{0} \leq {\sum }_{i ∈ A} {x}_{ij} \leq {β}_{j}^{1}$$

### Where:

A is the set of mentee members.
T is the set of mentor members.
xᵢⱼ=1 if we assign the i-th mentee to the j-th mentor and 0 otherwise for i∈A, j∈T
C(i,j) is the score if we assign the i-th mentee to the j-th mentor for i∈A, j∈T
aᵢ⁰ is the minimum and, aᵢ¹ is the maximum number of mentors assigned to the mentee i for i∈A
βⱼ⁰ is the minimum and βⱼ¹ is the maximum number of mentees assigned to mentor j for j∈T

The above problem can be solved by calculating the score C(i,j) for i∈A, j∈T and then solving the optimization problem using the score as the input. In some examples (aᵢ⁰, aᵢ¹)=(0,5) for all i—that is, mentees are matched with at most 5 mentors. Similarly, (βⱼ⁰, βⱼ¹)=(0,5)—that is every mentor gets at most 5 mentees. These parameters may be adjustable based upon a preference or decision made by an administrator of the social networking service, or based upon a preference of the mentor or mentee.

When members sign up to be matched with another member for the purpose of establishing a mentorship relationship, the system may ask them if they wish to be a mentor or mentee. The system may also collect a set of one or more preferences from them which are utilized in determining a set of matching mentors or mentees. For example, one or more of: a field of expertise preference, an industry preference, a mentorship topic, a network degree preference, a location proximity preference, and a colleague preference. After the preferences are collected, the system may determine a set of potential mentors or mentees and may present the set to the member. The member may select one or more of the potential mentors or mentees and a request may then be sent to that member to determine if they are also interested. If they are interested, then a mentorship connection may be formed on the social networking service. As an initial matter, the process is the same if mentees are provided with suggested mentors or if mentors are provided with selected mentees. For example, when members sign up to be mentees, the member may be provided at that time suggested mentor members that they may then request a mentorship relationship with. In other examples, mentors are provided with suggested mentees. In some examples, both mentors and mentees are provided with suggested counterparts in the mentee/mentor relationship.

The industry preference may be chosen from a predetermined list of industries and expresses a desire that matching members be in the selected industry. For example: accounting; airlines/aviation; alternative dispute resolution; banking; tech; law practice; machinery; veterinary; and the like. Field of expertise is a subject for which the member knows a lot about. The field of expertise preference may be chosen from a predetermined list and expresses a desire that matching members list the field of expertise as a field of expertise on their member profiles. As an example of the difference between industry and field of expertise, a member may work in the finance industry, but be a software developer. Thus, that member's industry is finance, but their field of expertise may be software development.

A mentorship topic may be selected from a predetermined list of topics for the mentorship. Examples include career advice, technical skill, communication skill, or other topics. The mentorship topic preference expresses a desire to be matched with members who are willing to mentor, or be mentored, about that topic. A network degree preference indicates a preference that the matched member be within a predetermined network distance (e.g., connection degree) from the member, for example—within two degrees of the member (which means that the recommended member must be connected to the member or connected to someone the member is connected with). A location proximity preference indicates that the user prefers to be recommended other members that are within a predetermined geographical proximity, which may be configured by the user, or may be predetermined by an administrator of the social networking service. The colleague preference indicates whether the user wants to be matched with someone in the same company. Other preferences may also be utilized, such as gender preferences (whether or not they want to be matched with someone of the same or different gender), school preferences (e.g., prefer matches that attended specified schools), and the like.

In some of examples, one or more of the preferences may be required. That is, members that do not meet one or more of the preferences may be filtered out. In other examples, the preferences are taken into account when creating the recommendation (e.g., when calculating C(i,j)). For example, the system may make field of expertise required (e.g., only recommending members with the same field of expertise preferences) and utilize the rest of the preferences when calculating C(i,j).

For example, the system may filter out all potential matches that did not select the same field of expertise value that the particular member selected. For example, if the member is looking for a mentor and prefers “software engineer” as a field of expertise for a mentor, all members who do not list “software engineer” on their member profiles may be filtered out.

Of the remaining members, the system may assign a score C(i,j) that represents a predicted compatibility between the potential mentor i and potential mentee j. C(i,j) may be calculated based upon a summation of a number of component scores. In some examples, C(i,j) may be a learned function (e.g., a machine learned model that is built using training data applied as input to a machine learning algorithm). The component scores may be weighted based upon a perceived, or learned importance of the feature(s) represented by the component scores to a quality match. Component scores may be based upon a number of compatibility features. Example features and the calculations used to calculate the component score for the features may include one or more of:
Seniority, Experience, and Degree differences between the mentor and mentee may be a component score of C(i,j) based upon seniority, experience, and degree differences. For example:
   The difference in experience between the mentor and mentee (delta experience);
   The difference in a standardized seniority level between the mentor and mentee (delta seniority)
   The difference in a standardized degree level or status between the mentor and mentee (delta degree).
      In some examples, this subcomponent may be calculated as follows:

If (a == 1)
{

If (b==1)

{

Component score = 15 * truncated normal pdf
(delta experience, mean =8, standard deviation
=3 )

} else
{

if (delta experience > 15)
{

Component score = 15 * truncated
normal pdf (delta experience, mean =
8, standard deviation = 3)

} else
{

Component score = −10

}

}

} else
{
Component score = −20
}

Where a is 1 if the delta seniority is greater than or equal to 1 and the delta experience is greater than 0, otherwise a is 0; b is 1 if the delta degree is >=−200 otherwise b is 0. Truncated normal PDF is a truncated normal probability density function with the following arguments: 1. The value at which the density is being calculated, the mean of the distribution, and the standard deviation of the distribution. In some examples, the distribution is truncated from below at 0 (and in some examples, not truncated at the other end).
Industry match may be a component score and may be calculated based upon whether or not the industry of the potential mentor and the potential mentee match. In some examples, if there is a match, this component score is 5 points, otherwise 0 points.
Network match may be a component score and may be calculated based upon whether or not the potential mentor and mentee are within a predetermined social network distance from each other, weighted based upon their preferences. In some examples, the component score may be 2.5*(networkmatch*(2*actual network distance−1)) where networkmatch is 2 if the mentor indicated a preference for mentees within their network (regardless of the potential mentee's preference); 1 if the mentee indicated a preference for mentors within their networks and the mentor did not indicate such a preference; and 0 if neither indicated a preference. Actual network distance is a distance in degrees (e.g., 1^{st} degree, 2^{nd} degree, 3^{rd} degree or other degree of connection).
Colleague Match may be a component score and may be calculated based upon whether the potential mentor and potential mentee work at the same company. For example, the colleague match component score may be calculated as 2*(colleague match*(2*colleague−1)) where colleague match is 2 if the mentor indicated a preference for mentees that are colleagues (regardless of the potential mentee's preference); 1 if the mentee indicated a preference for mentors that are colleagues and the mentor did not indicate such a preference; and 0 if neither indicated a preference.
Location Match—may be a component score and may be calculated based upon whether the potential mentor and potential mentee are geographically near each other. For example, the location match score may be 2*(location match*(2*distance−1)) where location match is 2 if the mentor indicated a preference for mentees that are close (regardless of the potential mentee's preference); 1 if the mentee indicated a preference for mentors that are close and the mentor did not indicate such a preference; and 0 if neither indicated a preference. The distance is a geographical distance between them, calculated using a home or work location entered into their respective social networking service member profiles.
Topic match may be a component score and may be calculated based upon whether the potential mentor and potential mentee enter the same mentorship topics when signing up. If they entered the same topics, then the score is 1 point, otherwise it is 0 points.
Proximity match may be a component score and may be calculated based upon how close the potential mentor and potential mentee are (this factor may be used in addition to, or instead of the location match factor). The score may be calculated as e^{-distance}
Skills match may be a component score and may be calculated based upon the number of skills the potential mentor and potential mentee have in common. Skills may be determined based upon skills entered by the members into their member profiles. The score may be 1 point for each matching skill.
School match may be a component score and may be calculated based upon the number of common schools attended by the potential mentor and potential mentee. Schools may be determined based upon attendance entered by the members into their member profiles. The score may be 1 point for each matching school.
Industry Match in the Member Profile may be a component score and may be calculated based upon whether the industry listed in the member profile of the potential mentor matches the industry listed in the member profile of the potential mentee. For example, increases the score by 1 if the industry listed in the member profile of the potential mentor matches the industry listed in the member profile of the potential mentee.
Gender match may be a component score and may be calculated based upon a match between the gender of the potential mentor and potential mentee. In some examples, if the potential mentor and potential mentee list the same genders on their respective member profiles the score is increased by 1.

In some examples, all the component scores of all the features described above may be calculated and summed to produce the C(i,j) score. For example, C(i,j) may be calculated as:

Seniority, experience and degree subcomponent score+industry match subscore+network match subscore+colleague subscore+location match subscore+topic match subscore+proximity match subscore+skills match subscore+school match subscore+industry match (member profile) subscore+gender match subscore.

In other examples, less than all of the described features may be utilized. In other examples, other features may be utilized. In some examples, weights may be utilized that are multiplied by each subscore, these weights may be predetermined by an administrator of the social networking service. These weights may be adjusted based upon feedback given by users of the system. Feedback may be explicit (e.g., a user reporting that the matches are not good matches), or implicit (the user selecting one of the matches or rejecting others). This feedback, along with the component scores may be utilized to train a regression model (e.g., linear or logistic regression) that then outputs a set of weights to apply when calculating C(i,j).

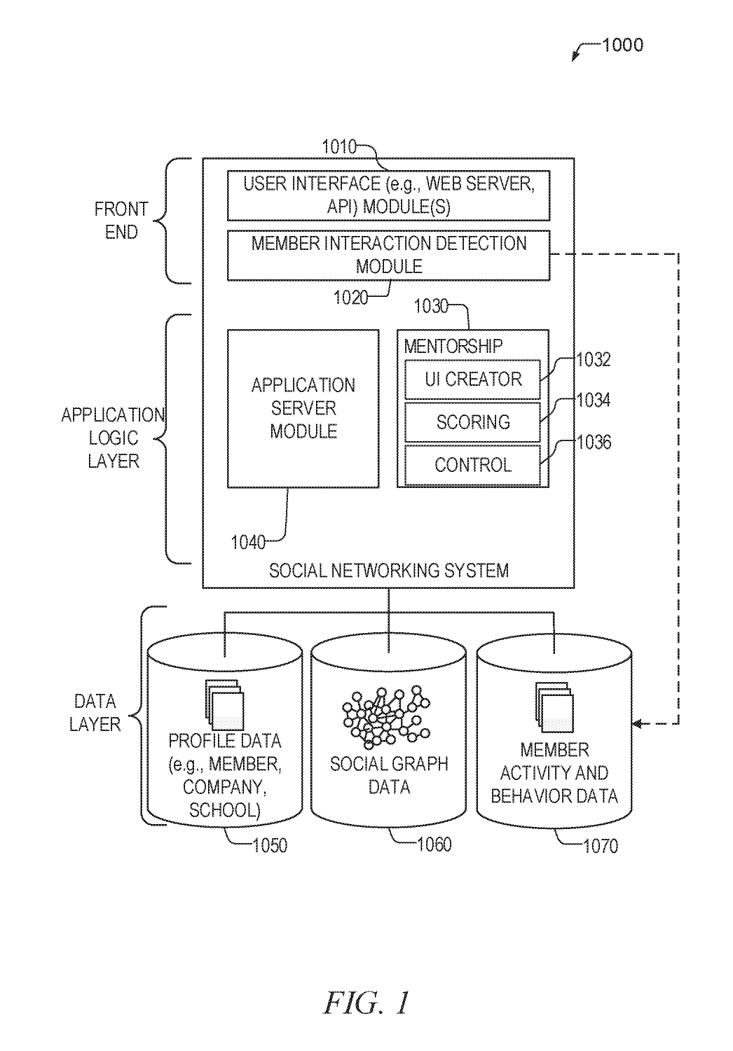

FIG. 1 is a block diagram showing the functional components of a social networking service 1000. As shown in FIG. 1, a front end may comprise a user interface module (e.g., a web server) 1010, which receives requests from various client-computing devices, and communicates appropriate responses to the requesting client devices. For example, the user interface module(s) 1010 may receive requests in the form of Hypertext Transport Protocol (HTTP) requests, or other network-based, application programming interface (API) requests (e.g., from a dedicated social networking service application running on a client device). In addition, a member interaction and detection module 1020 may be provided to detect various interactions that members have with different applications, services and content presented. As shown in FIG. 1, upon detecting a particular interaction, the member interaction and detection module 1020 logs the interaction, including the type of interaction and any meta-data relating to the interaction, in the member activity and behavior database 1070.

An application logic layer may include one or more various application server modules 1040, which, in conjunction with the user interface module(s) 1010, generate various graphical user interfaces (e.g., web pages) with data retrieved from various data sources in the data layer. With some embodiments, application server module 1040 is used to implement the functionality associated with various applications and/or services provided by the social networking service as discussed above.

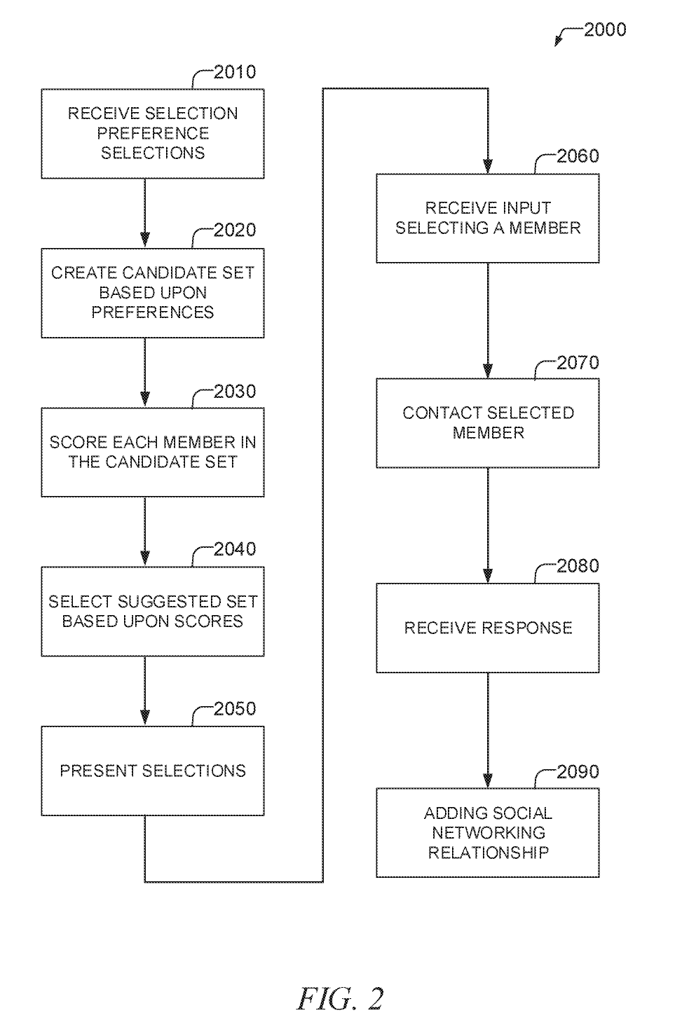

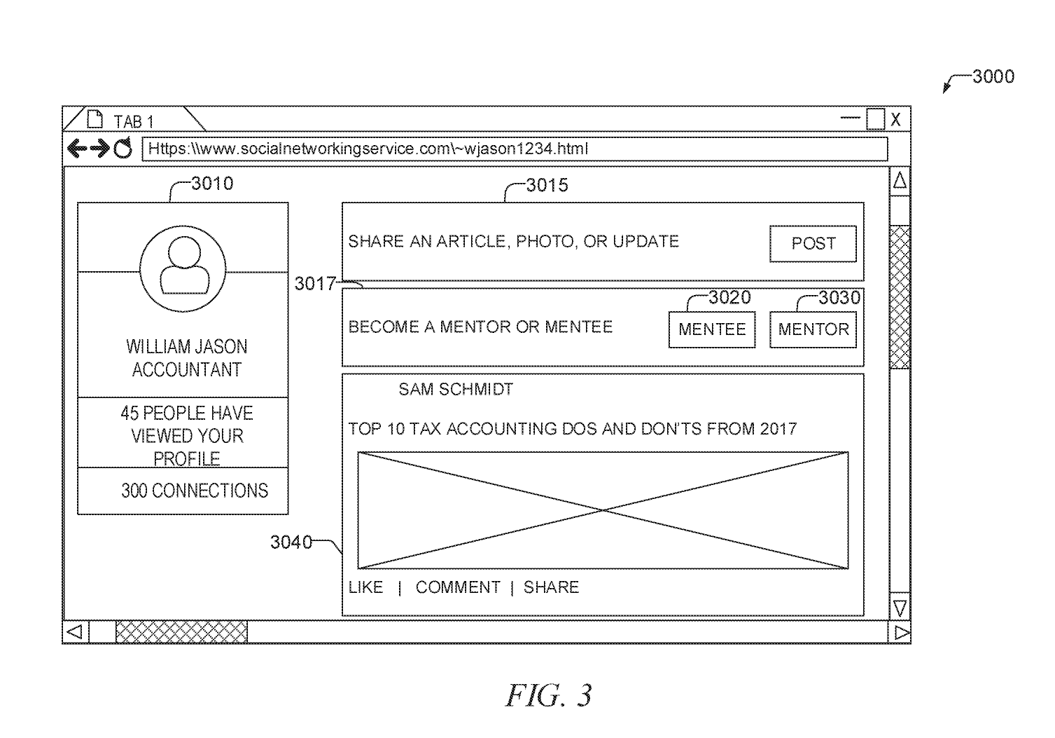

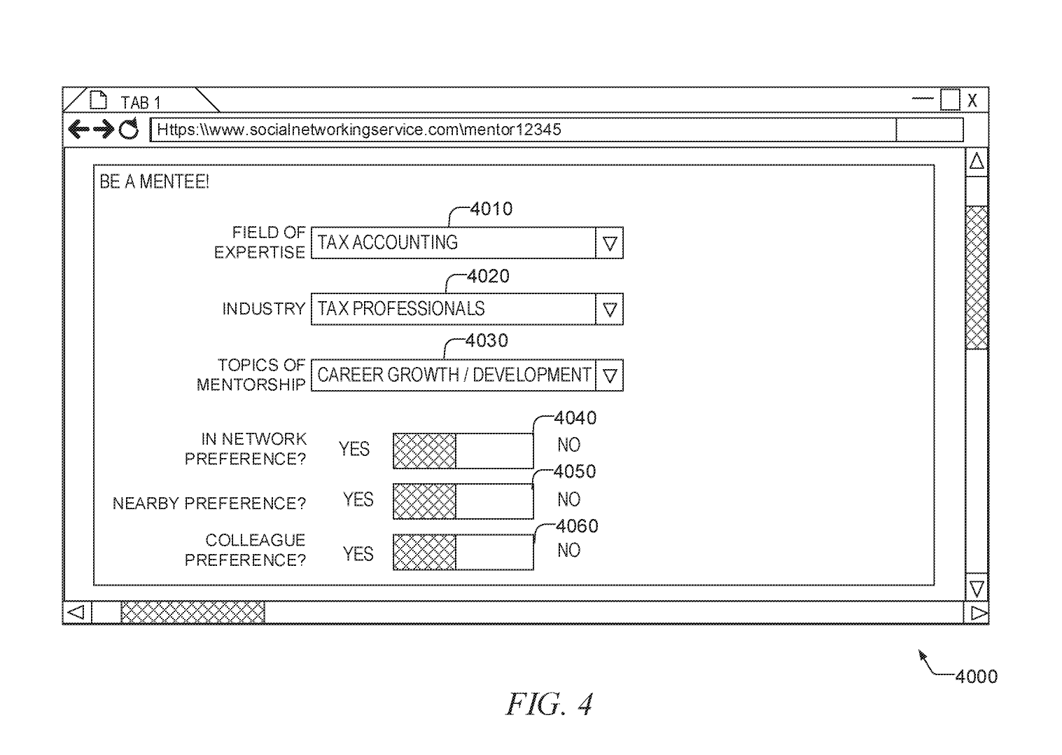

Application layer may include mentorship module 1030 which may include a User Interface (UI) creator module 1032 which may interface with the user interface module 1010 to produce one or more user interfaces (such as GUIs) which may provide members with graphical user interface elements that allow them to indicate that they wish to be matched with a mentor, a mentee, or both. The UI creator module 1032 may interface with the user interface module 1010 to produce one or more user interfaces that allow members to select desired preferences for a mentee or mentor. For example, GUIs such as those shown in FIGS. 3 and 4. The mentorship module 1030 may include a scoring module 1034 for calculating the C(i,j) score (and the component scores) for potential mentee/mentor matches. Control module 1036 may control the process, for example, by determining and/or filtering a list of potential mentors or mentees to display to the user and then scoring the list of potential mentors or mentees. For example, control module 1036 may perform the operations of FIG. 2 in conjunction with the UI creator module 1032 and the scoring module 1034.

The data layer may include one or more data storage entities or databases such as profile database 1050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the profile database 1050. Similarly, when a representative of an organization initially registers the organization with the social networking service, the representative may be prompted to provide certain information about the organization. This information may be stored, for example, in the profile database 1050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 1060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 1 by the member activity and behavior database 1070.

With some embodiments, the social networking service 1000 provides an application programming interface (API) module with the user interface module 1010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

FIG. 2 shows a flowchart of a method 2000 for matching mentors and mentees according to some examples of the present disclosure. FIG. 2 may be performed for the mentor to select mentees or by the mentee to select mentors, or by both. At operation 2010 the system may receive preference selections from potential mentees and potential mentors. For example, users who wish to be a mentee or mentor may indicate one or more preferences through a GUI. Example preferences include a field of expertise, an industry, a topic of mentorship, a preference to have a mentor/mentee in the member's network (e.g., within a predetermined network distance), a preference to have a mentor/mentee nearby geographically, and a preference to have the mentor/mentee work at the same company (e.g., a colleague).

After entering the preferences, the system attempts to match the member with a mentor or mentee (depending on whether they volunteered to be a mentor or mentee). At operation 2020 the system may create a candidate set of members. For example, for potential mentees, the candidate set may be all members of the social networking service who have agreed to be a mentor. For potential mentors, the candidate set may be all members of the social networking service who have indicated they would like to be mentored. In some examples, when determining candidate mentors for a mentee member, the system may treat one or more of the preferences as a filter to exclude members not meeting those preferences. For example, the system may require a field of expertise to match between the potential mentor and potential mentees. For example, when determining candidate mentors for a mentee, the system may exclude all potential mentors that do not have the desired expertise of the potential mentee.

At operation 2030, the system may calculate the C(i,j) of each member in the candidate set. This may be calculated using a weighted summation utilizing the features discussed above. In other examples, machine learning algorithms such as logistic regression may be utilized. The system may utilize member profile data (including all the features previously discussed) of mentors and mentees labeled based upon how good a match (or how bad a match) the mentor/mentee combination is to train a model to use for future predictions. For example, the model may be created using a regression algorithm. This machine learned model may be updated with explicit feedback from users. This feedback may be explicit or implicit. Explicit feedback may be a user that explicitly tells the user that the match is acceptable or not. Implicit feedback may be inferred from a user's rejection (or lack of selection) of a candidate mentor/mentee, or from a user's selection (or acceptance) of a candidate mentor/mentee.

At operation 2040, based upon the scores, a suggested set of mentors/mentees may be generated. For example, the system may select the suggested set that comprises members that optimize the function given earlier of:

Σ_{i∈A}Σ_{j∈T}C(i,j)xᵢⱼ

One method of optimization may be to select the highest scoring members in the suggested set such that the constraints (e.g., (aᵢ⁰, aᵢ¹) and (βⱼ⁰, βⱼ¹)) are satisfied. Thus, for a particular mentee member, the highest ranking aᵢ¹ mentors may be shown. If the mentee member only selects one of the presented mentors, then the next time the mentee is presented mentor recommendations, the mentee may be shown aᵢ¹−1 of the highest ranking mentor recommendations (which may be re-run later in time to factor in new mentor candidates and changed preferences). Likewise, for a particular mentee member, the highest ranking βᵢ¹ mentees may be shown. If the mentor member only selects one of the presented mentees, then the next time the mentor is presented mentee recommendations, the mentor may be shown βⱼ¹−1 of the highest ranking mentee recommendations (which may be re-run later in time to factor in new mentee candidates and changed preferences).

At operation 2050 the system may present the suggested set to the member who may determine which of the other members presented in the suggested set they wish to connect in a mentorship relationship with. At operation 2060 the system may receive one or more selections of the presented suggested set. At operation 2070 the selected members are contacted to determine if they consent to being a mentor/mentee to that person. At operation 2080 the response is received. If it is an acceptance, then at operation 2090 a connection between the mentor and mentee is stored in the social networking service as part of the social graph (e.g., an edge is added between the mentor and mentee in the social graph database 1060).

As noted previously, the creation of a mentor/mentee relationship may provide one or more features or benefits to the mentor/mentee pair that are normally not present. For example, the mentor/mentee relationship may correspond to certain information access privileges. For example, mentors, mentees, or both may access additional information on non-public areas of each other's profiles. In other examples, additional communication options may be allowed on the social networking service. For example, the members may be second degree connections and so may not be able to directly message each other. The establishment of a mentor/mentee relationship may not change the degree of connection (in some examples), but may open up the ability to directly communication with each other. In some examples, the mentor/mentee relationship creates a connection between the mentor/mentee such that the direct communication may be utilized.

In some examples, the social networking service may track the mentor/mentee relationship. The relationship may be classified into one of a plurality of stages. For example:

| Stage | Description |
|---|---|
| Suggestion View | The member has viewed the suggestion |
| | to connect with a mentor/mentee |
| Suggestion Like | The member has received at least one |
| | suggestion that they like |
| Match | The mentor and mentee both agree to |
| | start the conversation |
| Post-Match conversation | The mentor and mentee have started |
| | communicating |
| Relationship phase | A conversation of greater than a |
| | predetermined depth has occurred |

The phases may be tracked based upon frequency of communications between mentor and mentee on the social networking service. For example, conversation depth may be determined based upon frequency of communications. For example, depth may be calculated based upon frequency. Other example factors include length of communications, forms of communications, and the like.

FIG. 3 shows a diagram of an example GUI 3000 of a user profile page of a member. User information section 3010 may show the member's name, the number of people that have viewed the member's profile, the number of connections that the member has, and a picture of the member. Box 3015 may allow the member to post an article, photo, or other updates through a “post” user interface element. Box 3017 includes user interface elements 3020 and 3030 that, when selected, indicate the member's desire to act as a mentor (user interface element 3030) and a mentee (user interface element 3020). Box 3040 shows content shared by others with this member, and the like.

FIG. 4 shows a diagram of an example graphical user interface (GUI) 4000 of a user profile page of a user that is shown to a member. The GUI 4000 may be displayed in response to selecting user interface elements 3020 or 3030 of FIG. 3 (or other user interface elements used to indicate an interest in being a mentor/mentee). Field of expertise drop down user interface element 4010 allows the member to determine a field of expertise for the mentorship. Industry drop down 4020 may allow the member to determine an industry for the mentorship. Topics of mentorship drop down 4030 may allow the member to determine a topic for the mentorship. In some examples, the choices present in the drop down boxes 4010-4030 may be independent of one another. That is, the options for a particular drop down box may not depend on the values selected for a different one of the drop down boxes. In other examples, selection of a particular value for a particular one of the drop down boxes may determine the selectable values for particular other ones of the drop down boxes. For example, by selecting a “Tax Accounting” field of expertise, the industry and topics of mentorship drop down boxes 4020, 4030 may show only industries and topics related to tax accounting. Graphical Switches 4040, 4050, and 4060 allow members to indicate whether they prefer a mentor (or mentee) in the member's network, nearby, or as a colleague. These preferences may be utilized in scoring each potential mentor/mentee as previously discussed.

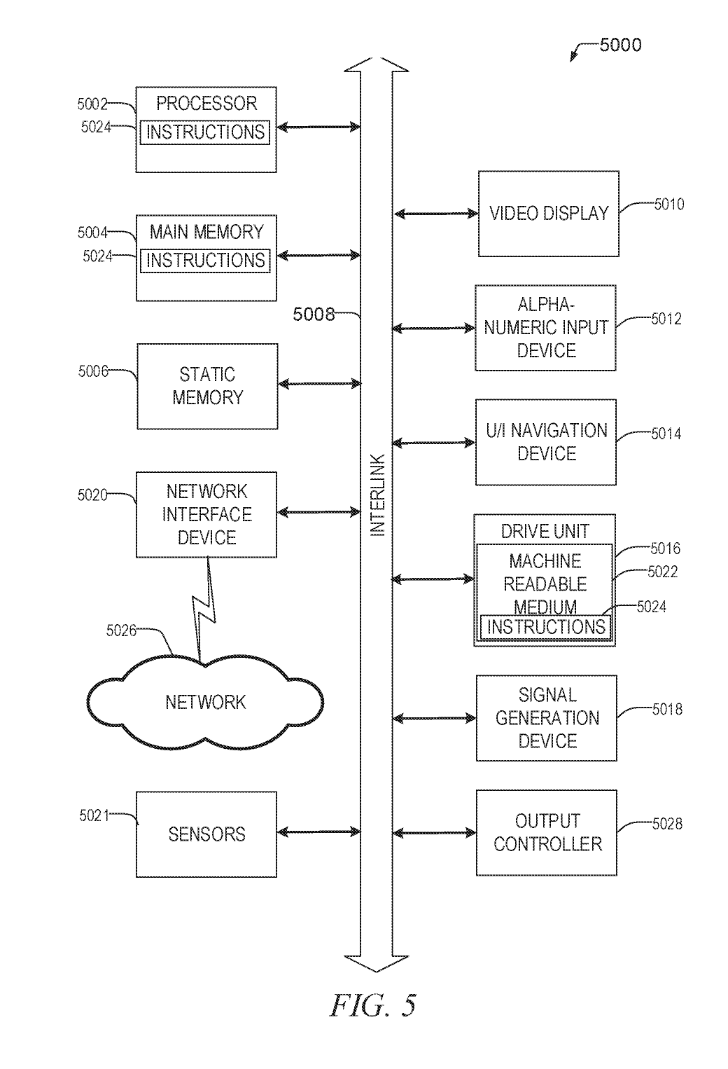

FIG. 5 illustrates a block diagram of an example machine 5000 upon which any one or more of the techniques (e.g., methodologies) discussed herein may perform. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 5000 may wholly or partially implement the social networking service of FIG. 1, the method of FIG. 2, as well as present the GUI of FIGS. 3 and 4. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

### Notes and Other Examples—the Following are Non-Limiting Examples

Example 1 is a computer-implemented method for mentor-mentee matching, the method comprising: receiving a selection of a set of preferences in a first Graphical User Interface (GUI) from a member of a social networking service; creating a candidate set of other members of the social networking service based upon the set of preferences; calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member; selecting a suggested set of members based upon the mentorship match scores of the candidate set of members; presenting at least one member in the suggested set of members in a second GUI to the member, the second GUI comprising a graphical user interface element that allows the user to select one of the members in the suggested set of members; receiving a selected member from the member via the second graphical user interface; and receiving an acceptance of the mentorship relationship from the selected member.

In Example 2, the subject matter of Example 1 optionally includes wherein the member is a mentor in the mentorship relationship and the particular member is a mentee in the mentorship relationship.

In Example 3, the subject matter of any one or more of Examples 1-2 optionally include wherein the member is a mentee in the mentorship relationship and the particular member is a mentor in the mentorship relationship.

In Example 4, the subject matter of any one or more of Examples 1-3 optionally include adding a social networking connection between the member and the selected member indicating the mentorship relationship; and enabling direct messaging between the member and the selected member responsive to adding the social networking connection, wherein the direct messaging would normally not be allowed for the member and the selected member absent the mentorship relationship.

In Example 5, the subject matter of any one or more of Examples 1-4 optionally include collecting data about communications between the member and the selected member and classifying the mentorship relationship as one of: a post match conversation and a relationship phase.

In Example 6, the subject matter of any one or more of Examples 1-5 optionally include accessing a plurality of content items; analyzing each of the plurality of content items to determine a set of the plurality of content items that is related to the set of preferences; and presenting a third GUI to the member, the third GUI presenting the set of the plurality of content items and comprising graphical user interface elements that allow the member to select and send ones of the set of the plurality of content items to the selected member.

In Example 7, the subject matter of any one or more of Examples 1-6 optionally include wherein the scoring comprises utilizing a weighted summation algorithm, and wherein: a first argument is based upon the at least one preference in the set of preferences, a second argument is based upon the proximity score, and a third argument is based upon at least one preference expressed by the particular candidate member.

In Example 8, the subject matter of Example 7 optionally includes wherein a fourth argument is a delta experience score which comprises a truncated normal distribution of a difference in years of professional experience between the particular candidate member and the member.

In Example 9, the subject matter of any one or more of Examples 7-8 optionally include wherein a fourth argument is a score that reflects a number of matching skills possessed by the member and skills possessed by the particular candidate member as indicated on their respective member profiles.

In Example 10, the subject matter of any one or more of Examples 1-9 optionally include determining a maximum number of mentor relationships for the member; determining a maximum number of mentee relationships for the particular member; and wherein selecting a suggested set of members based upon the mentorship match scores comprises maximizing the set of mentorship match scores given the maximum number of mentor relationships and the maximum number of mentee relationships.

In Example 11, the subject matter of any one or more of Examples 1-10 optionally include wherein the mentorship match score is a weighted summation of a plurality of component scores, each of the plurality of component scores multiplied by a weight, the weight updated based upon user feedback.

Example 12 is a non-transitory machine readable medium comprising instructions for mentor-mentee matching, the instructions, when performed by a machine, causes the machine to perform operations comprising: receiving a selection of a set of preferences in a first Graphical User Interface (GUI) from a member of a social networking service; creating a candidate set of other members of the social networking service based upon the set of preferences; calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member; selecting a suggested set of members based upon the mentorship match scores of the candidate set of members; presenting at least one member in the suggested set of members in a second GUI to the member, the second GUI comprising a graphical user interface element that allows the user to select one of the members in the suggested set of members; receiving a selected member from the member via the second graphical user interface; and receiving an acceptance of the mentorship relationship from the selected member.

In Example 13, the subject matter of Example 12 optionally includes wherein the member is a mentor in the mentorship relationship and the particular member is a mentee in the mentorship relationship.

In Example 14, the subject matter of any one or more of Examples 12-13 optionally include wherein the member is a mentee in the mentorship relationship and the particular member is a mentor in the mentorship relationship.

In Example 15, the subject matter of any one or more of Examples 12-14 optionally include wherein the operations further comprise: adding a social networking connection between the member and the selected member indicating the mentorship relationship; and enabling direct messaging between the member and the selected member responsive to adding the social networking connection, wherein the direct messaging would normally not be allowed for the member and the selected member absent the mentorship relationship.

In Example 16, the subject matter of any one or more of Examples 12-15 optionally include wherein the operations further comprise: collecting data about communications between the member and the selected member and classifying the mentorship relationship as one of: a post match conversation and a relationship phase.

In Example 17, the subject matter of any one or more of Examples 12-16 optionally include wherein the operations further comprise: accessing a plurality of content items; analyzing each of the plurality of content items to determine a set of the plurality of content items that is related to the set of preferences; and presenting a third GUI to the member, the third GUI presenting the set of the plurality of content items and comprising graphical user interface elements that allow the member to select and send ones of the set of the plurality of content items to the selected member.

In Example 18, the subject matter of any one or more of Examples 12-17 optionally include wherein the operations of scoring comprise the operations of utilizing a weighted summation algorithm, and wherein: a first argument is based upon the at least one preference in the set of preferences, a second argument is based upon the proximity score, and a third argument is based upon at least one preference expressed by the particular candidate member.

In Example 19, the subject matter of Example 18 optionally includes wherein a fourth argument is a delta experience score which comprises a truncated normal distribution of a difference in years of professional experience between the particular candidate member and the member.

In Example 20, the subject matter of any one or more of Examples 18-19 optionally include wherein a fourth argument is a score that reflects a number of matching skills possessed by the member and skills possessed by the particular candidate member as indicated on their respective member profiles.

In Example 21, the subject matter of any one or more of Examples 12-20 optionally include wherein the operations further comprise: determining a maximum number of mentor relationships for the member; determining a maximum number of mentee relationships for the particular member; and wherein selecting a suggested set of members based upon the mentorship match scores comprises maximizing the set of mentorship match scores given the maximum number of mentor relationships and the maximum number of mentee relationships.

In Example 22, the subject matter of any one or more of Examples 12-21 optionally include wherein the mentorship match score is a weighted summation of a plurality of component scores, each of the plurality of component scores multiplied by a weight, the weight updated based upon user feedback.

Example 23 is a system for mentor-mentee matching, the system comprising: a processor; a memory, the memory storing instructions, which when performed by the processor, causes the system to perform operations comprising: receiving a selection of a set of preferences in a first Graphical User Interface (GUI) from a member of a social networking service; creating a candidate set of other members of the social networking service based upon the set of preferences; calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member, selecting a suggested set of members based upon the mentorship match scores of the candidate set of members; presenting at least one member in the suggested set of members in a second GUI to the member, the second GUI comprising a graphical user interface element that allows the user to select one of the members in the suggested set of members; receiving a selected member from the member via the second graphical user interface; and receiving an acceptance of the mentorship relationship from the selected member.

In Example 24, the subject matter of Example 23 optionally includes wherein the member is a mentor in the mentorship relationship and the particular member is a mentee in the mentorship relationship.

In Example 25, the subject matter of any one or more of Examples 23-24 optionally include wherein the member is a mentee in the mentorship relationship and the particular member is a mentor in the mentorship relationship.

In Example 26, the subject matter of any one or more of Examples 23-25 optionally include wherein the operations further comprise: adding a social networking connection between the member and the selected member indicating the mentorship relationship; and enabling direct messaging between the member and the selected member responsive to adding the social networking connection, wherein the direct messaging would normally not be allowed for the member and the selected member absent the mentorship relationship.

In Example 27, the subject matter of any one or more of Examples 23-26 optionally include wherein the operations further comprise: collecting data about communications between the member and the selected member and classifying the mentorship relationship as one of: a post match conversation and a relationship phase.

In Example 28, the subject matter of any one or more of Examples 23-27 optionally include wherein the operations further comprise: accessing a plurality of content items; analyzing each of the plurality of content items to determine a set of the plurality of content items that is related to the set of preferences; and presenting a third GUI to the member, the third GUI presenting the set of the plurality of content items and comprising graphical user interface elements that allow the member to select and send ones of the set of the plurality of content items to the selected member.

In Example 29, the subject matter of any one or more of Examples 23-28 optionally include wherein the operations of scoring comprise the operations of utilizing a weighted summation algorithm, and wherein: a first argument is based upon the at least one preference in the set of preferences, a second argument is based upon the proximity score, and a third argument is based upon at least one preference expressed by the particular candidate member.

In Example 30, the subject matter of Example 29 optionally includes wherein a fourth argument is a delta experience score which comprises a truncated normal distribution of a difference in years of professional experience between the particular candidate member and the member.

In Example 31, the subject matter of any one or more of Examples 29-30 optionally include wherein a fourth argument is a score that reflects a number of matching skills possessed by the member and skills possessed by the particular candidate member as indicated on their respective member profiles.

In Example 32, the subject matter of any one or more of Examples 23-31 optionally include wherein the operations further comprise: determining a maximum number of mentor relationships for the member; determining a maximum number of mentee relationships for the particular member; and wherein selecting a suggested set of members based upon the mentorship match scores comprises maximizing the set of mentorship match scores given the maximum number of mentor relationships and the maximum number of mentee relationships.

In Example 33, the subject matter of any one or more of Examples 23-32 optionally include wherein the mentorship match score is a weighted summation of a plurality of component scores, each of the plurality of component scores multiplied by a weight, the weight updated based upon user feedback.

Example 34 is a device for mentor-mentee matching, the device comprising: means for receiving a selection of a set of preferences in a first Graphical User Interface (GUI) from a member of a social networking service; means for creating a candidate set of other members of the social networking service based upon the set of preferences; means for calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member; means for selecting a suggested set of members based upon the mentorship match scores of the candidate set of members; means for presenting at least one member in the suggested set of members in a second GUI to the member, the second GUI comprising a graphical user interface element that allows the user to select one of the members in the suggested set of members; means for receiving a selected member from the member via the second graphical user interface; and means for receiving an acceptance of the mentorship relationship from the selected member.

In Example 35, the subject matter of Example 34 optionally includes wherein the member is a mentor in the mentorship relationship and the particular member is a mentee in the mentorship relationship.

In Example 36, the subject matter of any one or more of Examples 34-35 optionally include wherein the member is a mentee in the mentorship relationship and the particular member is a mentor in the mentorship relationship.

In Example 37, the subject matter of any one or more of Examples 34-36 optionally include means for adding a social networking connection between the member and the selected member indicating the mentorship relationship; and means for enabling direct messaging between the member and the selected member responsive to adding the social networking connection, wherein the direct messaging would normally not be allowed for the member and the selected member absent the mentorship relationship.

In Example 38, the subject matter of any one or more of Examples 34-37 optionally include means for collecting data about communications between the member and the selected member and classifying the mentorship relationship as one of: a post match conversation and a relationship phase.

In Example 39, the subject matter of any one or more of Examples 34-38 optionally include means for accessing a plurality of content items; means for analyzing each of the plurality of content items to determine a set of the plurality of content items that is related to the set of preferences; and means for presenting a third GUI to the member, the third GUI presenting the set of the plurality of content items and comprising graphical user interface elements that allow the member to select and send ones of the set of the plurality of content items to the selected member.

In Example 40, the subject matter of any one or more of Examples 34-39 optionally include wherein the scoring comprises utilizing a weighted summation algorithm, and wherein: a first argument is based upon the at least one preference in the set of preferences, a second argument is based upon the proximity score, and a third argument is based upon at least one preference expressed by the particular candidate member.

In Example 41, the subject matter of Example 40 optionally includes wherein a fourth argument is a delta experience score which comprises a truncated normal distribution of a difference in years of professional experience between the particular candidate member and the member.

In Example 42, the subject matter of any one or more of Examples 40-41 optionally include wherein a fourth argument is a score that reflects a number of matching skills possessed by the member and skills possessed by the particular candidate member as indicated on their respective member profiles.

In Example 43, the subject matter of any one or more of Examples 34-42 optionally include means for determining a maximum number of mentor relationships for the member; means for determining a maximum number of mentee relationships for the particular member; and wherein selecting a suggested set of members based upon the mentorship match scores comprises means for maximizing the set of mentorship match scores given the maximum number of mentor relationships and the maximum number of mentee relationships.

In Example 44, the subject matter of any one or more of Examples 34-43 optionally include wherein the mentorship match score is a weighted summation of a plurality of component scores, each of the plurality of component scores multiplied by a weight, the weight updated based upon user feedback.

What is claimed is:

1. A non-transitory machine readable medium comprising instructions for mentor-mentee matching, the instructions, when performed by a machine, causes the machine to perform operations comprising:
receiving a selection of a set of preferences in a first Graphical User Interface (GUI) from a member of a social networking service;
creating a candidate set of other members of the social networking service based upon the set of preferences;
calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member;
selecting a suggested set of members based upon the mentorship match scores of the candidate set of members;
presenting at least one member in the suggested set of members in a second GUI to the member, the second GUI comprising a graphical user interface element that allows the user to select one of the members in the suggested set of members;
receiving a selected member from the member via the second graphical user interface;
receiving an acceptance of the mentorship relationship from the selected member.

2. The non-transitory machine readable medium of claim 1, wherein the member is a mentor in the mentorship relationship and the particular member is a mentee in the mentorship relationship.

3. The non-transitory machine readable medium of claim 1, wherein the member is a mentee in the mentorship relationship and the particular member is a mentor in the mentorship relationship.

4. The non-transitory machine readable medium of claim 1, wherein the operations further comprise:
adding a social networking connection between the member and the selected member indicating the mentorship relationship; and
enabling direct messaging between the member and the selected member responsive to adding the social networking connection, wherein the direct messaging would normally not be allowed for the member and the selected member absent the mentorship relationship.

5. The non-transitory machine readable medium of claim 1, wherein the operations further comprise:
collecting data about communications between the member and the selected member and classifying the mentorship relationship as one of: a post match conversation and a relationship phase.

6. The non-transitory machine readable medium of claim 1, wherein the operations further comprise:
accessing a plurality of content items;
analyzing each of the plurality of content items to determine a set of the plurality of content items that is related to the set of preferences; and
presenting a third GUI to the member, the third GUI presenting the set of the plurality of content items and comprising graphical user interface elements that allow the member to select and send ones of the set of the plurality of content items to the selected member.

7. The non-transitory machine readable medium of claim 1, wherein the operations of scoring comprise the operations of utilizing a weighted summation algorithm, and wherein:
a first argument is based upon the at least one preference in the set of preferences, a second argument is based upon the proximity score, and a third argument is based upon at least one preference expressed by the particular candidate member.

8. The non-transitory machine readable medium of claim 7, wherein a fourth argument is a delta experience score which comprises a truncated normal distribution of a difference in years of professional experience between the particular candidate member and the member.

9. The non-transitory machine readable medium of claim 7, wherein a fourth argument is a score that reflects a number of matching skills possessed by the member and skills possessed by the particular candidate member as indicated on their respective member profiles.

10. The non-transitory machine readable medium of claim 1, wherein the operations further comprise:
determining a maximum number of mentor relationships for the member;
determining a maximum number of mentee relationships for the particular member; and
wherein selecting a suggested set of members based upon the mentorship match scores comprises maximizing the set of mentorship match scores given the maximum number of mentor relationships and the maximum number of mentee relationships.

11. The non-transitory machine readable medium of claim 1, wherein the mentorship match score is a weighted summation of a plurality of component scores, each of the plurality of component scores multiplied by a weight, the weight updated based upon user feedback.

12. A computer-implemented method for mentor-mentee matching, the method comprising:
receiving a selection of a set of preferences in a first Graphical User Interface (GUI) from a member of a social networking service;
creating a candidate set of other members of the social networking service based upon the set of preferences;
calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member;
selecting a suggested set of members based upon the mentorship match scores of the candidate set of members;
presenting at least one member in the suggested set of members in a second GUI to the member, the second GUI comprising a graphical user interface element that allows the user to select one of the members in the suggested set of members;
receiving a selected member from the member via the second graphical user interface;
receiving an acceptance of the mentorship relationship from the selected member; and
adding a social networking connection between the member and the selected member indicating the mentorship relationship.

13. The method of claim 12, wherein the member is a mentor in the mentorship relationship and the particular member is a mentee in the mentorship relationship.

14. The method of claim 12, wherein the member is a mentee in the mentorship relationship and the particular member is a mentor in the mentorship relationship.

15. The method of claim 12, comprising:
adding a social networking connection between the member and the selected member indicating the mentorship relationship; and
enabling direct messaging between the member and the selected member responsive to adding the social networking connection, wherein the direct messaging would normally not be allowed for the member and the selected member absent the mentorship relationship.

16. The method of claim 12, comprising:
accessing a plurality of content items;
analyzing each of the plurality of content items to determine a set of the plurality of content items that is related to the set of preferences; and
presenting a third GUI to the member, the third GUI presenting the set of the plurality of content items and comprising graphical user interface elements that allow the member to select and send ones of the set of the plurality of content items to the selected member.

17. The method of claim 12, wherein the scoring comprises utilizing a weighted summation algorithm, and wherein:
a first argument is based upon the at least one preference in the set of preferences, a second argument is based upon the proximity score, and a third argument is based upon at least one preference expressed by the particular candidate member.

18. A system for mentor-mentee matching, the system comprising:
a processor;
a memory, the memory storing instructions, which when performed by the processor, causes the system to perform operations comprising:
receiving a selection of a set of preferences in a first Graphical User Interface (GUI) from a member of a social networking service;
creating a candidate set of other members of the social networking service based upon the set of preferences;
calculating a mentorship match score for each particular candidate member in the candidate set, the mentorship match score calculated based upon: at least one preference in the set of preferences, at least one preference expressed by the particular candidate member, and at least one social networking proximity score between the particular candidate member and the member;
selecting a suggested set of members based upon the mentorship match scores of the candidate set of members;
presenting at least one member in the suggested set of members in a second GUI to the member, the second GUI comprising a graphical user interface element that allows the user to select one of the members in the suggested set of members;
receiving a selected member from the member via the second graphical user interface;
receiving an acceptance of the mentorship relationship from the selected member; and
adding a social networking connection between the member and the selected member indicating the mentorship relationship.

19. The system of claim 18, wherein the member is a mentor in the mentorship relationship and the particular member is a mentee in the mentorship relationship.

20. The system of claim 18, wherein the member is a mentee in the mentorship relationship and the particular member is a mentor in the mentorship relationship.

21. The system of claim 18, wherein the operations further comprise:
adding a social networking connection between the member and the selected member indicating the mentorship relationship; and
enabling direct messaging between the member and the selected member responsive to adding the social networking connection, wherein the direct messaging would normally not be allowed for the member and the selected member absent the mentorship relationship.

22. The system of claim 18, wherein the operations further comprise:
collecting data about communications between the member and the selected member and classifying the mentorship relationship as one of: a post match conversation and a relationship phase.

23. The system of claim 18, wherein the operations further comprise:
accessing a plurality of content items;
analyzing each of the plurality of content items to determine a set of the plurality of content items that is related to the set of preferences; and
presenting a third GUI to the member, the third GUI presenting the set of the plurality of content items and comprising graphical user interface elements that allow the member to select and send ones of the set of the plurality of content items to the selected member.

24. The system of claim 18, wherein the operations of scoring comprise the operations of utilizing a weighted summation algorithm, and wherein:
a first argument is based upon the at least one preference in the set of preferences, a second argument is based upon the proximity score, and a third argument is based upon at least one preference expressed by the particular candidate member.

25. The system of claim 18, wherein the operations further comprise:
determining a maximum number of mentor relationships for the member;
determining a maximum number of mentee relationships for the particular member; and
wherein selecting a suggested set of members based upon the mentorship match scores comprises maximizing the set of mentorship match scores given the maximum number of mentor relationships and the maximum number of mentee relationships.
